(19) United States
(12) Patent Application Publication
(10) Pub. No.: US 2014/0074645 A1
(43) Pub. Date: Mar. 13, 2014

(54) Bid Assessment Analytics

(71) Applicant: Doug Ingram, Potomac, MD (US)

(72) Inventor: Doug Ingram, Potomac, MD (US)

(73) Assignee: CENTURION RESEARCH SOLUTIONS, Chantilly, VA (US)

(21) Appl. No.: 13/612,242

(22) Filed: Sep. 12, 2012

(51) Int. Cl. G06Q 30/00

(52) U.S. Cl. 705/26.4

(57) ABSTRACT

Methods, computer readable media, and apparatuses for performing bid assessments and outputting bid assessment scores are presented. A bid assessment analytics system may retrieve a set of predetermined bid assessment questions relating to a bidding opportunity and present the bid assessment questions via a user interface. Answers to the bid assessment questions may be received and scores may be determined for one or more bid assessment factors. Bid assessment weights associated with specific organizations, users, and/or industries may be calculated and stored based on data input for previous bidding opportunities and the outcomes of the previous bidding opportunities. The applicable bid assessment weights may be retrieved and used to calculate the bid assessment factor scores and/or overall bid assessment scores for bidding opportunities.

### BACKGROUND

Governmental entities and private sector companies seeking to procure products or services commonly initiate bidding processes among potential suppliers. Bidding invitations such as requests for proposals (RFPs), requests for quotations (RFQs), requests for tenders (RFTs), calls for bids, and other types of invitations may be used by governmental or private sector entities in many different industries, such as finance, engineering, manufacturing, military, and many others. For example, a request for proposals (RFP) for an engineering project may describe the product and service requirements for the project, the project timeline, the potential contract price, the expectations and due date for supplier proposals, and other details regarding the project and/or the bidding process.

In response to RFPs and other bidding invitations, different suppliers or contractors interested in providing the products or services outlined in the RFP may prepare and submit detailed proposals. Supplier proposals may describe the technical details and specifications of the supplier's products and services, descriptions of the supplier's previous experiences, qualifications, and resources, along with additional information describing the supplier's qualifications. Preparing such proposals may be a costly and time consuming process for suppliers, potentially requiring hundreds or thousands of employee hours and thousands or even millions of dollars. For example, an RFP for a manufacturing, engineering, or military project may require potential suppliers to design, prototype, test, and price one or more proposed implementations of the project to be submitted with the supplier's proposal. Thus, while successful proposals may win valuable contracts for the supplier, unsuccessful proposals may waste substantial company and employee resources.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Described herein are methods, computer readable media, and apparatuses for performing bid assessments and outputting bid assessment scores and report. A bid assessment analytics system may retrieve and present a set of bid assessment questions to a user in an organization (e.g., contractor or supplier) via a user interface. The bid assessment questions, and the answers received via the user interface, may relate to a bidding opportunity such as a request for proposals (RFP) from a governmental entity or private sector company. The bid assessment analytics system may receive answers to the bid assessment questions, and retrieve scores associated with each answer. Different subsets of the bid assessment questions may be associated with different bid assessment factors, and the system may calculate scores for each of the bid assessment factors. The bid assessment analytics system may output the bid assessment factor scores and/or an overall bid assessment score for the bidding opportunity, providing data and analysis to users and organizations regarding the likelihood of winning the bidding opportunity.

The bid assessment analytics system may store bid assessment adjustment values associated with specific organizations, users, and/or industries for bidding opportunities. Bid assessment adjustment values may correspond to score adjustments to be applied for specific bid assessment questions or combinations of questions. When performing a bid assessment, the system may retrieve and use the applicable bid assessment adjustment values and use these values to calculate the bid assessment question scores, bid assessment factor scores and/or overall bid assessment scores. Different sets of bid assessment adjustment values may be stored and applied for different users, organizations, and industries, and may be calculated by the system based on previous bidding opportunities and outcomes.

### BRIEF DESCRIPTION OF THE DRAWINGS

The present disclosure is illustrated by way of example and not limited in the accompanying figures in which like reference numerals indicate similar elements and in which:

FIG. 1A illustrates an example of a computing environment, including a bid assessment analytics device, in which various aspects of the disclosure may be implemented.

FIG. 1B is a functional component diagram of an example bid assessment analytics device in accordance with one or more illustrative aspects described herein.

FIG. 2 is a flow diagram illustrating a method of performing bid assessment analytics and presenting bid assessment scores in accordance with one or more illustrative aspects described herein.

FIGS. 3A-3L are example user interfaces showing bid assessment questions and scoring for performing a bid assessment in accordance with one or more illustrative aspects described herein.

FIG. 4 is an example user interface showing scores for a bid assessment in accordance with one or more illustrative aspects described herein.

FIG. 5 is an example user interface showing scores and analyses for a set of bid assessments in accordance with one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

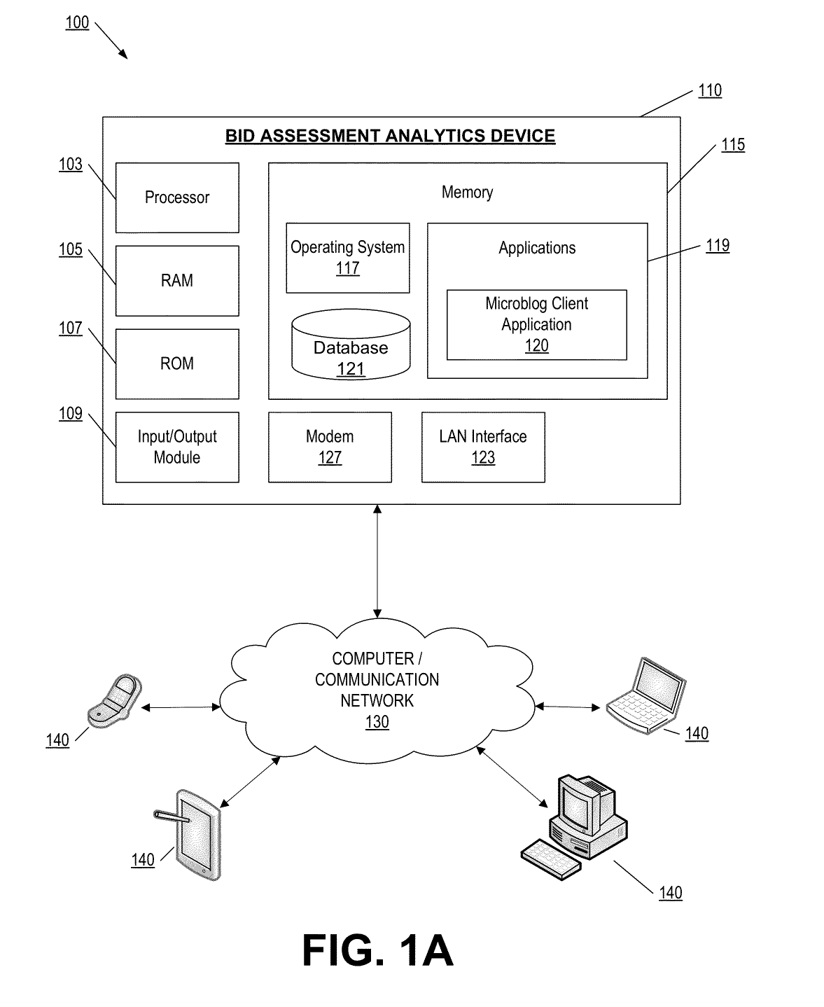

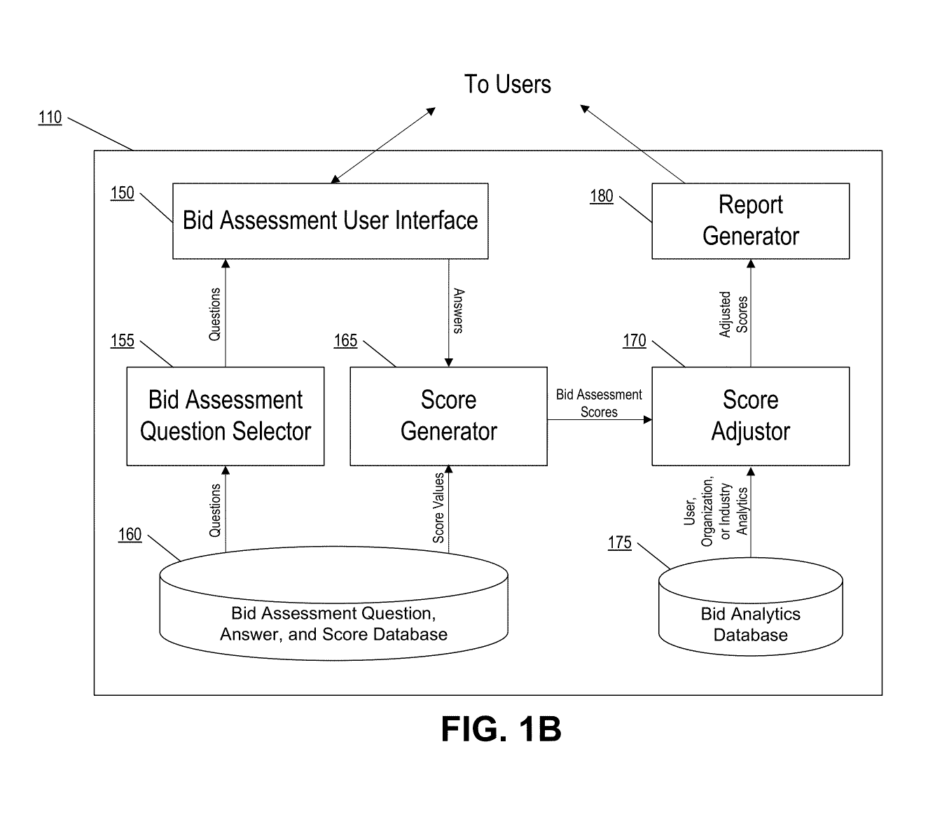

FIG. 1 illustrates a block diagram of a bid assessment analytics device 110 (e.g., personal computer, mobile device, smart phone, or personal digital assistant, etc.) in an example computing environment 100. A bid assessment refers to an analysis and determination of a likelihood of winning a bidding opportunity (or procurement opportunity), such as a product or service contract. For example, a bid assessment may analyze the likelihood of a specific supplier submitting a proposal and being awarded a contract or work order by the governmental or private sector entity. Device 110 may be used in accordance with one or more illustrative embodiments of the disclosure, for example, to perform bid assessments and analyses relating to bidding or procurement opportunities (e.g., requests for proposals, requests for quotations, calls for bids, and other bidding opportunities for government or private sector contracts). Thus, one or more bid assessment analytics devices 110 may store bid assessment data, analytics, and profiles, provide user interfaces for answering bid assessment questions, determining bid assessment scores, and performing bid assessment analysis. In certain examples, the computing device 110 may be configured as a server, configured to provide bid assessment functionality to one or more client devices 140 over a communication network 130. In other examples, the device 110 may be configured as a client device running one or more client applications to provide bid assessment functionality to users.

Device 110 may have a processor 103 for controlling overall operation of the device and its associated components, including random access memory (RAM) 105, read-only memory (ROM) 107, input/output (I/O) module 109, and memory 115. I/O module 109 may include a microphone, mouse, keypad, touch screen, scanner, optical reader, and/or stylus (or other input device(s)) through which a user of the bid assessment analytics system 110 may provide input, and may also include one or more of a speaker for providing audio output and a video display device (e.g., an attached monitor for a personal computer, integrated screen for a mobile device, etc.) for providing textual, audiovisual, and/or graphical output. Software may be stored within memory 115 and/or other storage system to provide instructions to processor 103 for enabling device 110 to perform various functions. For example, memory 115 may store software used by the device 110, such as an operating system 117, application programs 119, and an associated database 121. Alternatively, some or all of the computer executable instructions for device 110 may be embodied in hardware or firmware (not shown).

The bid assessment analytics system 110 may operate in a networked environment supporting connections to one or more remote computers, such as terminal devices 140. The device 110 may be connected to a local area network (LAN) via a LAN interface or adapter 123, and/or a wide area network (WAN) via a modem 127 or other network interface for establishing communications over the WAN, to establish communications with one or more computer/communications networks 130 (e.g., the Internet or any other suitable computer or communication network). It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computer/communication network 130 (along with one or more additional networks used in certain embodiments) may be any suitable computer network including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communication network 130 may include other suitable communications networks such as cable networks, dial-up or wireless cellular telephone networks, satellite networks, etc.

As noted above, in some examples, the bid assessment analytics system 110 and/or terminals 140 may be mobile terminals (e.g., mobile phones, smartphones, personal digital assistants, notebook computers, etc.) including various other components, such as a battery, speaker, and antennas (not shown). It should be understood that mobile terminal devices 140 may have limited functionality (e.g., displays, input/output) compared to other computing devices, and thus the user interface features for client bid assessment functionality may be limited for mobile client devices 140.

The devices and networks of computing environment 100 may be configured to provide a bid assessment analytics system, including storing and maintaining bid assessment information, providing bid assessment user interfaces, determining bid assessment scores based on bid assessment analytics, and performing related bid assessment functionality. In certain examples, the bid assessment analytics system 110 may operate independently to provide bid assessment analytics functionality to users via I/O module 109, and need not communicate with network 130 or any additional terminal devices 140. For instance, a standalone bid assessment analytics system 110 may include a computer program product stored by one or more computer-readable storage media to provide bid assessment analytics functionality to users. In other examples, various functionality of a bid assessment analytics system computing environment 100 may be located within bid assessment analytics system 110 and/or may be located remotely from the device 110. In such examples, the bid assessment analytics system 110 and terminal devices 140 may be operated in a client-server configuration, for instance, communicating via a web-based or client-server application in which the assessment analytics device 110 includes a web server allowing the terminal devices 140 (e.g., personal computers, laptop computers, tablet computers, smartphones, PDA's, etc.) to access web pages and download software from the bid assessment server 110 via a web browser application. In other examples, the bid assessment client terminals 140 may execute a standalone client software application configured to access a non-web based service or other application on the bid assessment server 110 in order to perform bid assessment functionality for organizations/users.

FIG. 1B is a functional component diagram of an example bid assessment analytics device 110. As described below in more detail, the device 110 may be configured to perform interactive bid assessments and provide bid assessment reports to users for bidding opportunities, such as requests for proposals (RFPs). Device 110 includes a bid assessment user interface component 150 configured to interact with users (e.g., client devices 140) by providing web-based or standalone user interfaces. Users may initiate bid assessments via the user interface component 150. After a bid assessment is initiated, a question selector component 155 may retrieve bid assessment questions from the bid assessment question database 160, and may provide the questions to the user interface 150 for presentation to the user. The components shown in FIG. 1B may be implemented in hardware, software, or a combination of the two.

When performing a bid assessment for an organization, there may be several different relevant factors relating to the likelihood of the organization winning the bidding opportunity. For example, the organization may be technically strong in the field of the bidding opportunity, but the organization might not have a good understanding of the cost dynamics that the customer will use to select a winning bid. In this case, the bid assessment may determine that the organization has a strong technical factor but a weak cost dynamics factor. The overall bid assessment scores and conclusions for the organization may be based on these factors, among others. Since different bid assessment factors relate to different subjects, the bid assessment question database 160 may store different subsets of bid assessment questions associated with each of the different factors. For example, a subset of technical bid assessment questions may be retrieved by the question selector 155 and presented to a technical employee, while a subset of financial questions for the same bid assessment may be presented to a different financial employee within the same organization.

After users provide answers to the bid assessment questions via the user interface 150, a score generator component 165 may use the users' answers to generate an initial bid assessment score for the organization's bid assessment. The score generator 165 may receive a user's answers to the bid assessment questions from the user interface 150, and may calculate initial bid assessment scores using score values (e.g., numeric values associated with each answer for each bid assessment question) retrieved from the bid assessment question database 160.

After initial bid assessment scores are generated based on the user's answers to the bid assessment questions, the score generator 165 may pass the initial scores to a score adjustor component 170. The score adjustor 170 may adjust the initial scores for the organization's bid assessment based on analytics data retrieved from a bid analytics database 175. Analytics data, described in more detail below, may be based on analyses of previous relevant bid assessments, for example, bid assessments performed by the same user, for the same organization, and/or within the same industry. Using the relevant analytics data from the bid analytics database 175, the score adjustor 170 may adjust the initial bid assessment scores to create adjusted bid assessment scores for the organization's bid assessment. The score adjustor 170 may provide the adjusted bid assessment scores to a report generator component 175.

The report generator component 175 may generate one or more bid assessment reports, for example, indicating the likelihood of the user winning the bidding opportunity. Bid assessment reports may be organized according to bid assessment factors (e.g., technical factors, management factors, cost factors, etc.) to show the organization's strengths and weaknesses with respect to winning the bidding opportunity. The report generator 175 may provide bid assessment reports to the user via the user interface 150 and/or various additional reporting techniques. At the completion of the bidding opportunity (e.g., after a winning bid has been selected), information about the bidding opportunity such (e.g., information regarding winning and losing bidder information) may be added to the bid analytics database 160 to be analyzed and used for future bid assessments.

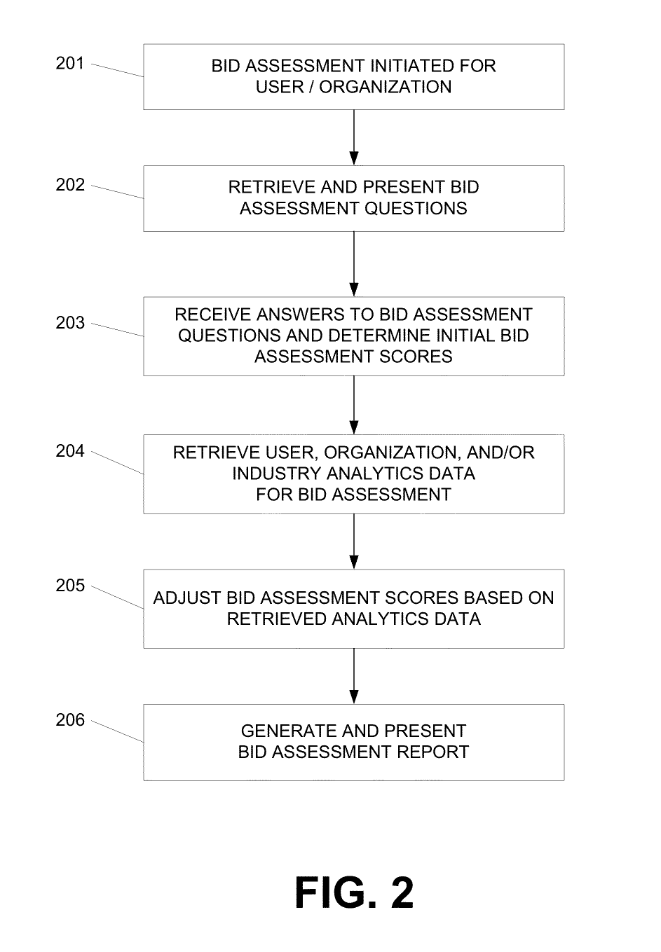

FIG. 2 illustrates a flow diagram for performing bid assessment analytics and presenting bid assessment scores in accordance with one or more illustrative aspects described herein. The embodiments described in reference to FIG. 2, and the other embodiments described herein, may be implemented by software executed on one or more computers, such as the bid assessment analytics system 110 of FIG. 1. In certain arrangements, the methods described herein may be performed by and/or in combination with multiple bid assessment analytics devices 110, for example, a bid assessment analytics server device in communication with one or more bid assessment analytics client devices.

In step 201, a bid assessment may be initiated for a user or organization at a bid assessment analytics system 110. In certain embodiments, the bid assessment analytics system 110 may be securely accessed by authorized users or entities only. Users may authenticate and login with a valid user identifier and password corresponding to their personal user credentials and/or the credentials of their organization. For instance, a supplier company that frequently operates as a government contractor may have multiple employees that share the same user credentials for accessing the bid assessment analytics system 110 to input data relating to past bidding opportunities, and to perform bid assessments for current and future bidding opportunities. Thus, past bidding data or bid assessments entered by one employee or for one department of an organization may be used to perform bid assessments by other employees or for other departments of the organization.

After a user logs onto or otherwise accesses the bid assessment analytics system 110, a user profile and/or an organization profile corresponding to the user may be retrieved from a database 121 within the device 110, or from an external database accessible to the device 110. As discussed in more detail below, user and organization profiles may store general user data and organization data (e.g., job titles of users, organization size, physical locations of facilities and resources, areas of expertise of the organization, departmental structure information, etc.) as well as analytics data regarding past bidding opportunities for the organization (e.g., answers to bid assessment questions for previous bidding opportunities of the organization, outcomes of the bidding opportunities, etc.).

A bid assessment may be initiated in step 201 by a user or organization, or automatically by the bid assessment analytics system 110. For example, information regarding a bidding opportunity (e.g., a request for proposals (RFP) from a governmental entity) may be input by a user of the system 110, such as a manager or technical personnel at a supplier company interested in submitting a proposal in response to the RFP. The information input by the user may include bid assessment information such as the RFP title, a product/service description and requirements associated with the RFP, the due date for responding to the RFP, the award contract value (e.g., estimated or actual), and the names and contact information of the personnel within the organization responsible for preparing and submitting the proposal for the RFP. In other examples, any information required to initiate a bid assessment on the system 110 may be input by an operator or administrator of the bid assessment analytics system 110 rather than by the organization, or may be retrieved or downloaded automatically by an application running on the bid assessment analytics system 110. For example, the system 110 may be configured to identify potential successful bidding opportunities for an organization (e.g., based on the organization's profile information and/or similar previous bidding opportunities of the organization), automatically retrieve information on such bidding opportunities, and notify the user/organization of the potential opportunities.

In step 202, the bid assessment analytics system 110 may retrieve and present a set of bid assessment questions to a user via one or more user interface screens. The user at a terminal device 140 may communicate with the bid assessment analytics system 110 remotely (i.e., over one or more communication networks 130) using a web browser or other client application, or may interact directly with the system 110. The bid assessment analytics system 110, alone or in combination with one or more client devices 140, may provide user interfaces for web-based or standalone client applications to allow users to interact with the system to perform bid assessments.

One or more sets of bid assessment questions may be retrieved in step 202 based on the user and organization, the specific bidding opportunity (e.g., information within the RFP or other bidding invitation), among other factors. The bid assessment questions, described in more detail below, may be designed to gather information for statistically determining the likelihood that the organization will submit a successful proposal to win the bidding opportunity. One or more sets of bid assessment questions may be stored in a database 160 in the bid assessment analytics system 110, or in another storage system. Sets of bid assessment questions may be industry-specific, organization-specific, and/or user-specific. For example, the set of bid assessment questions retrieved and presented to a supplier in one industry may be different than the set of bid assessment questions retrieved and presented to a different supplier in a different industry. Different sets of bid assessment questions may also be retrieved and presented to the same organization (e.g., supplier) for different RFPs and bidding opportunities, for example, within different lines of business or relating to different technologies.

The set of bid assessment questions retrieved and presented to a supplier for a bidding opportunity also may depend on the identity of the specific user interacting with the system 110. Different bid assessment questions stored in database 160 may be associated with different bid assessment factors, and thus may be designed to be answered by different users at an organization. For example, a subset of bid assessment questions relating to the organization's technical approach to the bidding opportunity may be designed to be answered by a technical employee of the organization, while another subset of the bid assessment questions relating to cost may be designed to be answered by a financial employee of the organization. The bid assessment analytics system 110 may be configured to retrieve and present different subsets of questions in step 202, depending on the identity of user as determined in step 201. Additionally, if a user or organization has previously identified a potential bidding opportunity, or previously begun a bid assessment process for the bidding opportunity, the system 110 may be configured to retrieve the in-progress bid assessment (e.g., bid assessment questions and previously stored answers) from a database 121 and allow the user to continue the in-progress bid assessment.

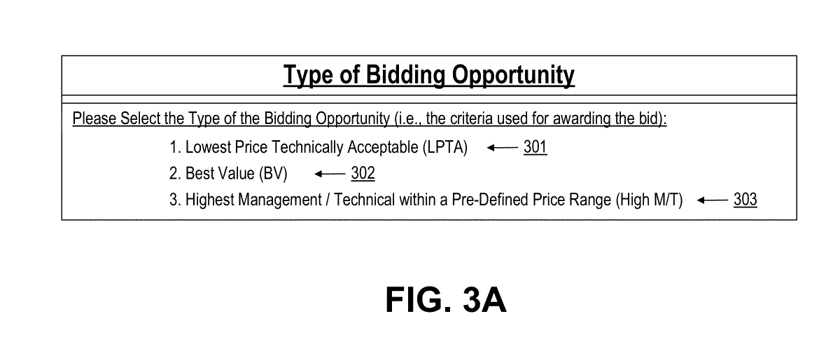

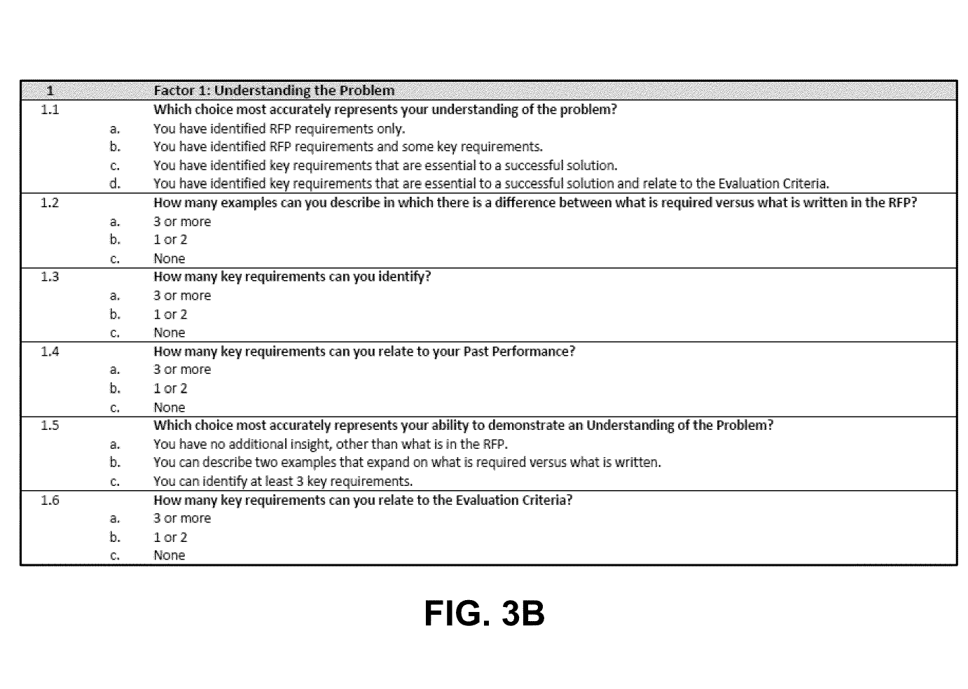

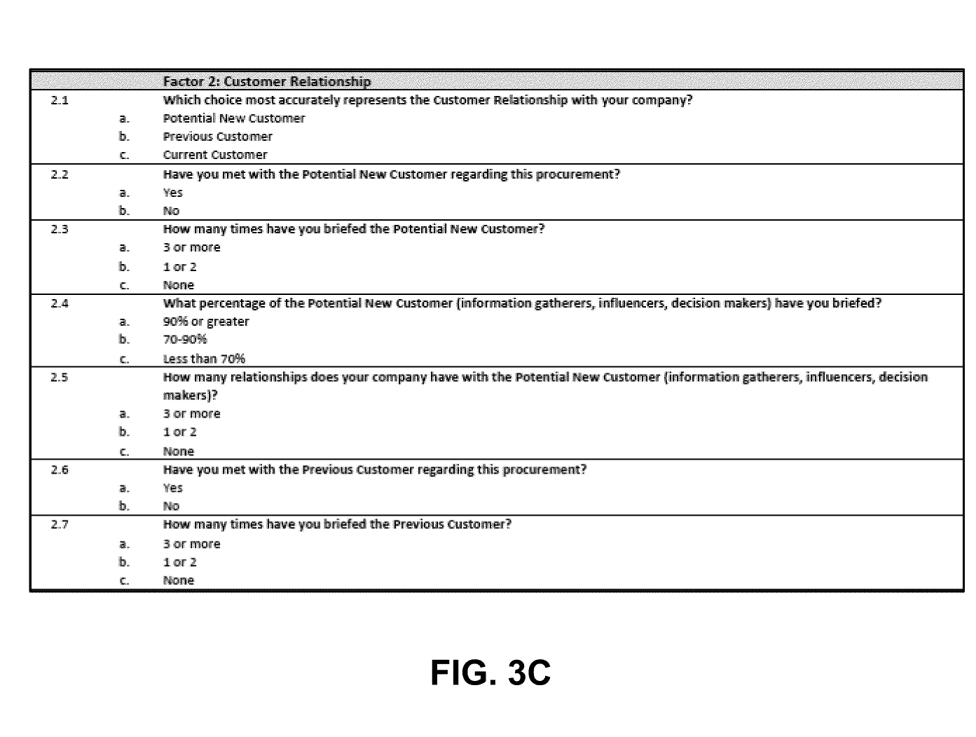

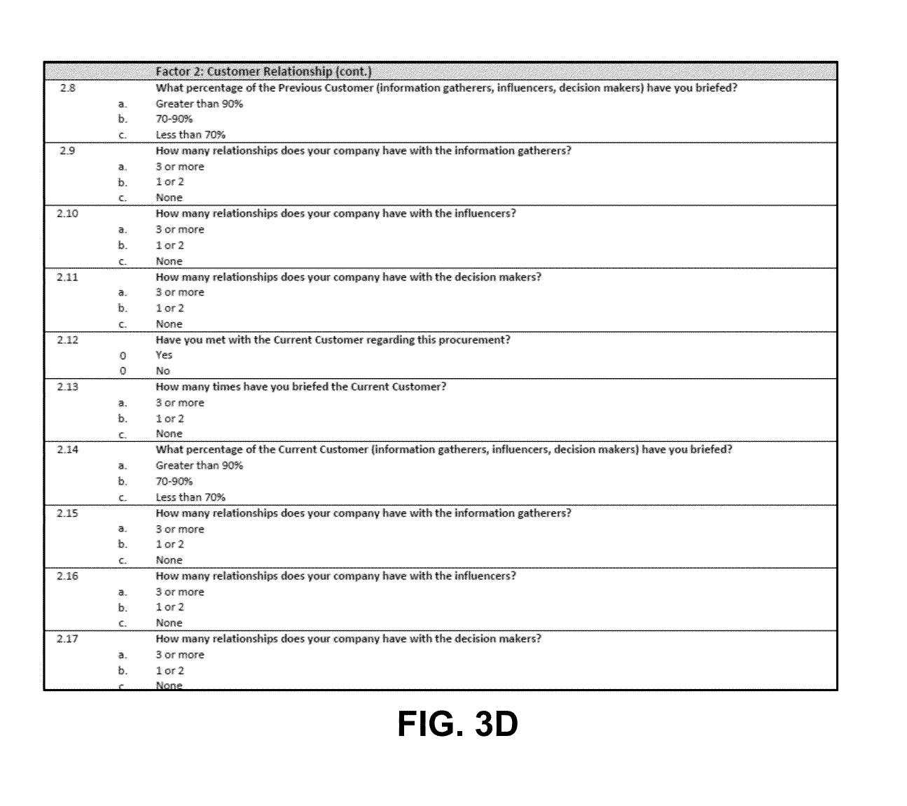

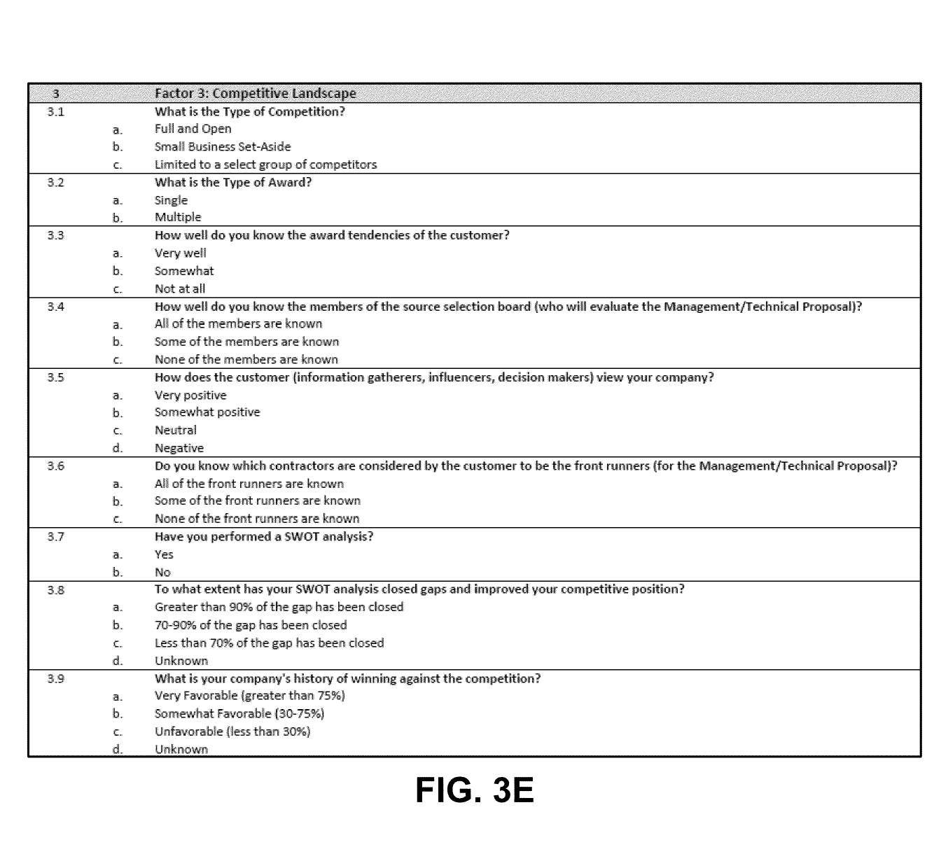

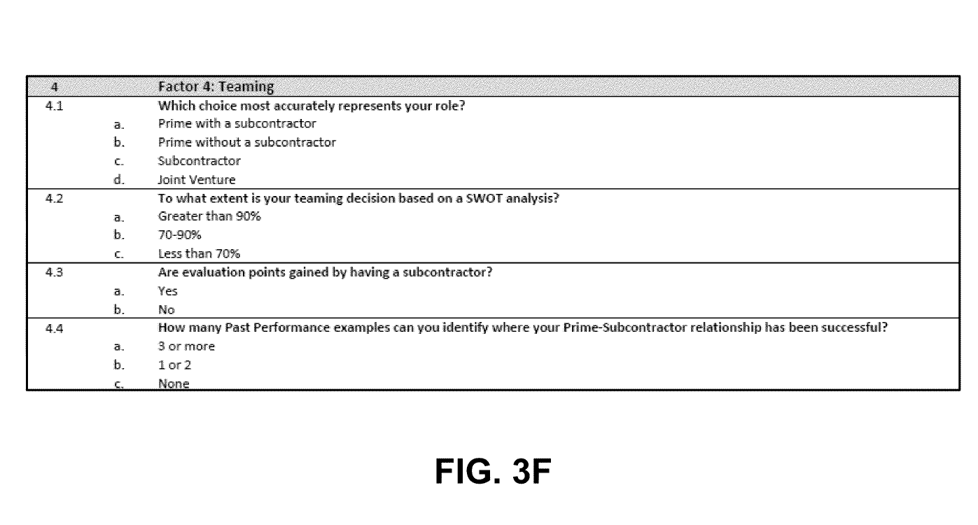

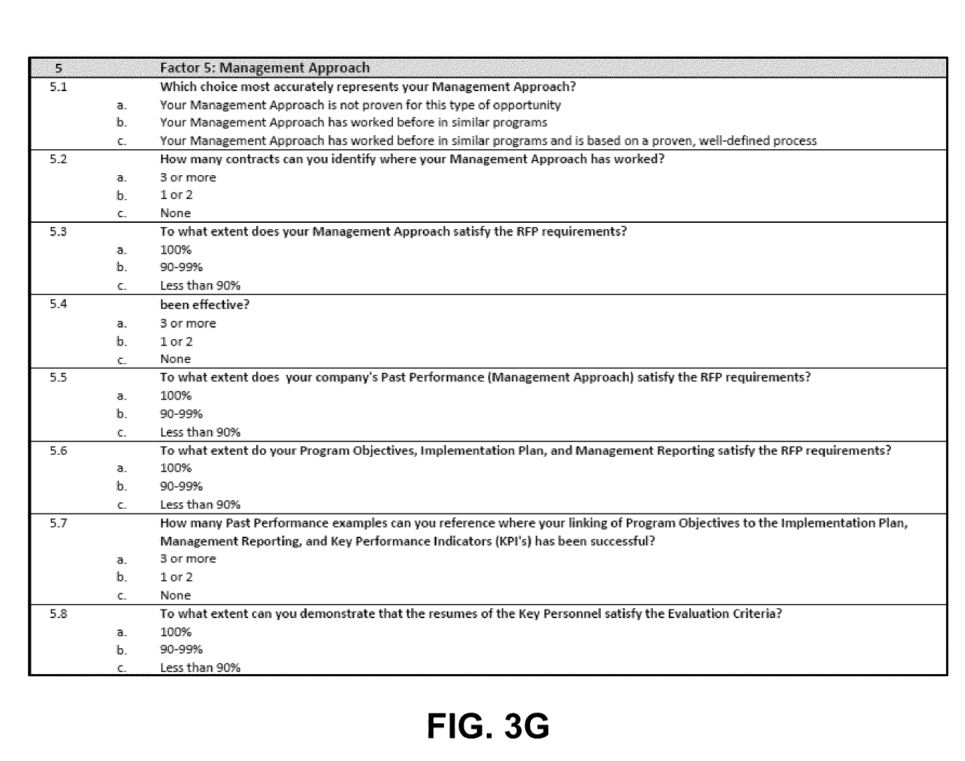

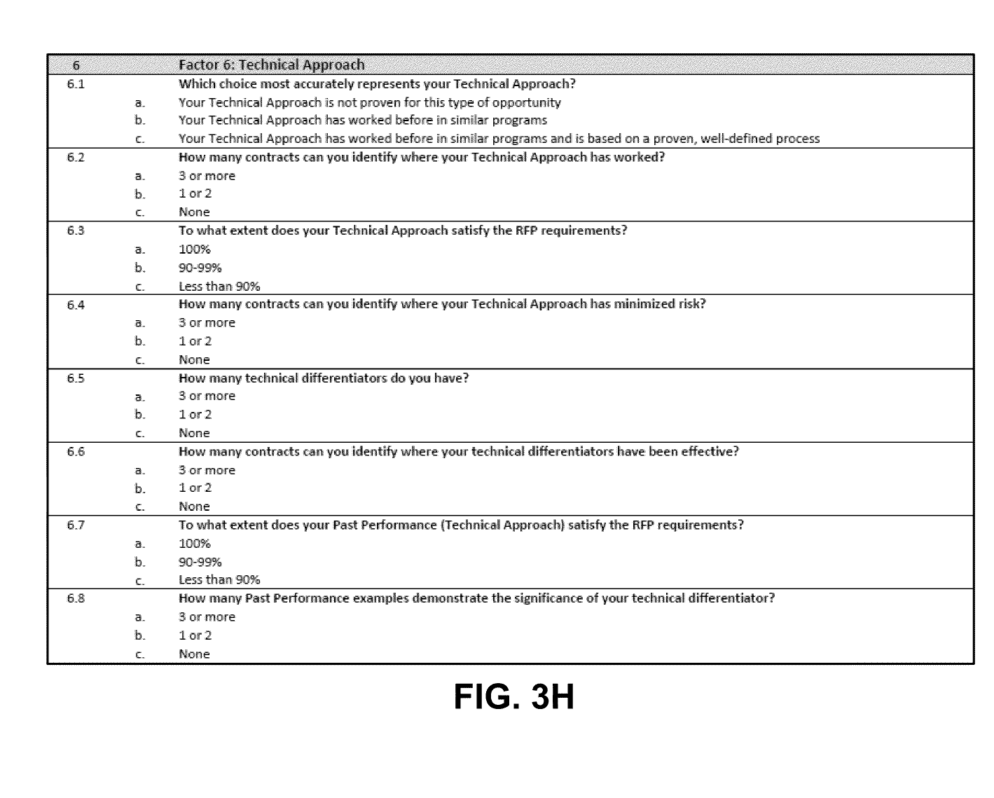

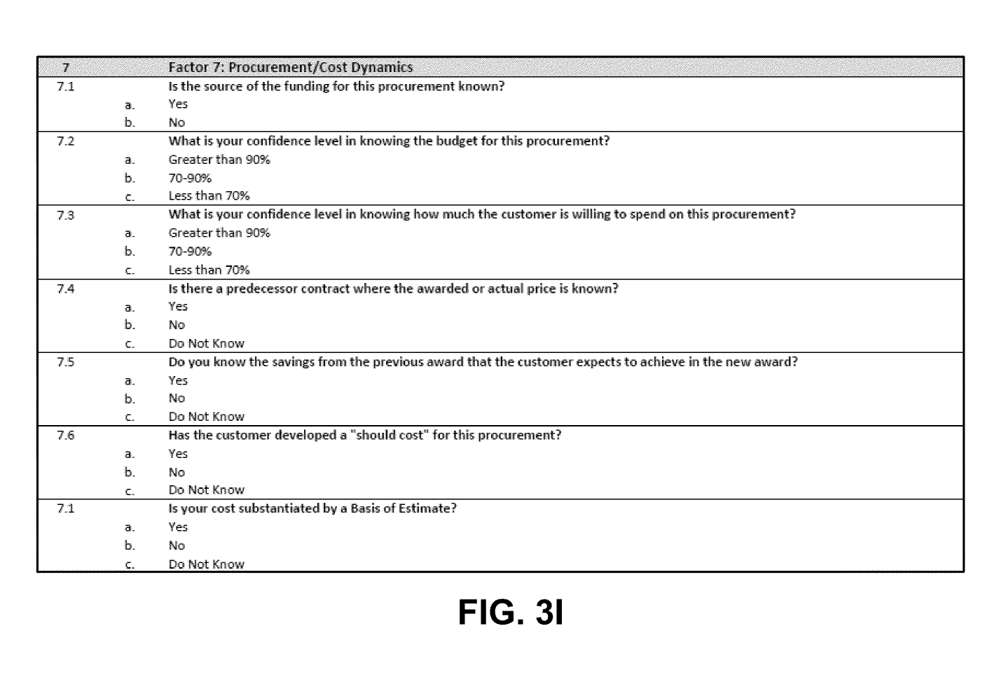

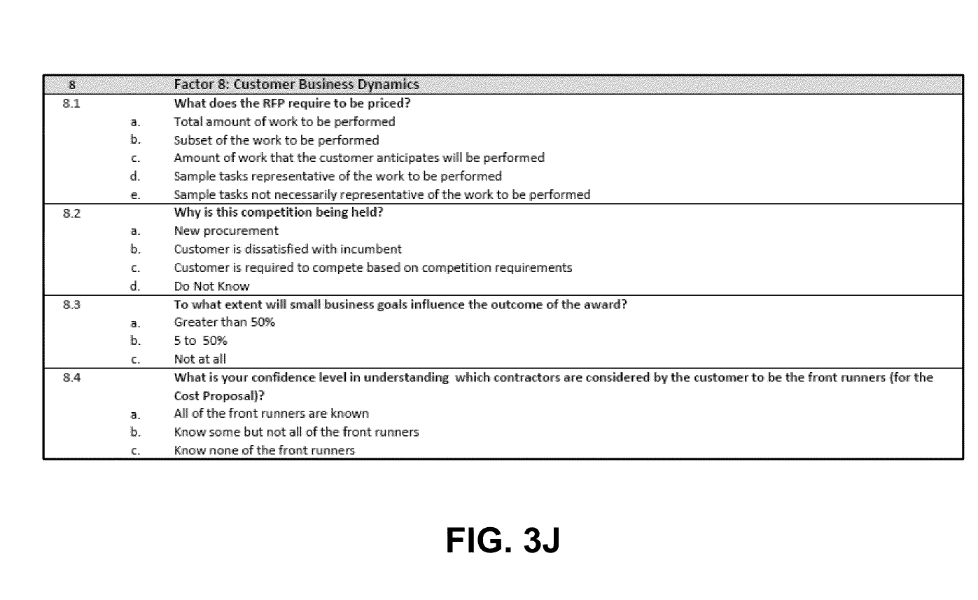

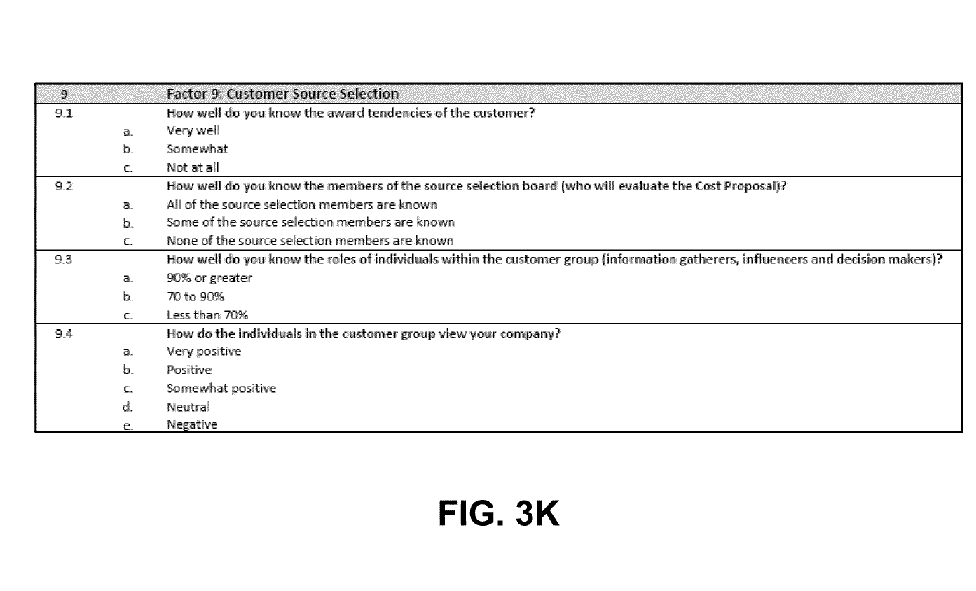

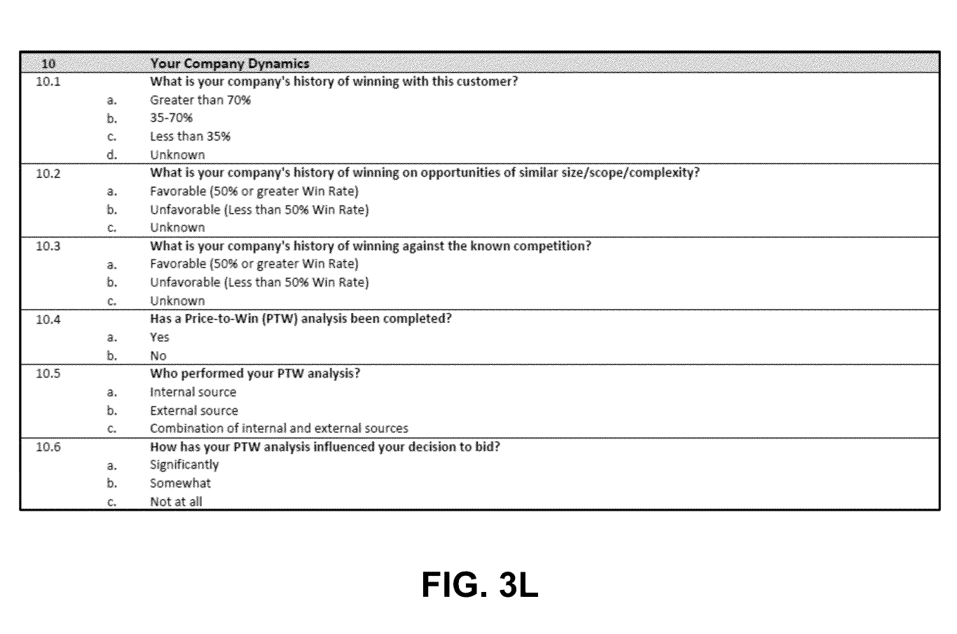

An example set of bid assessment questions is shown in FIGS. 3A-3L. The set of bid assessment questions in this example begins with a preliminary question in FIG. 3A to determine the basis for the award of the bidding opportunity (or bidding opportunity type). Certain bidding opportunities (e.g., RFPs from governmental entities) may indicate that the determination of the winning bid award (e.g., product or service contract) will be decided on a “Lowest Price Technically Acceptable” criteria (LPTA type 301), a “Best Value” criteria (BV type 302), or a “Highest Management/Technical with a Pre-Defined Price Range” criteria (High M/T type 303). In this example, the determination of the bidding opportunity type 301-303 may be used to determine which subsets of the remaining bid assessment questions (e.g., FIGS. 3B-3L) are subsequently retrieved and presented to the user for this bid assessment. Additionally, the subsequent bid assessment questions in FIGS. 3B-3L may be scored differently depending on the bidding opportunity type 301-303. Certain bid assessment factors and specific bid assessment questions may be more important for some bidding opportunity types, while different factors or questions may have greater importance for other bidding opportunity types. Furthermore, certain organizations may have greater likelihoods of winning bidding opportunities of certain types, and lesser likelihoods of winning bidding opportunities of other types. Thus, the remaining bid assessment questions (e.g., FIGS. 3B-3L) may be scored differently based on both bidding opportunity type and the organization performing the bid assessment.

FIGS. 3B-3L show a series of multiple choice bid assessment questions to allow the bid assessment analytics system 110 to collect information for statistically determining the likelihood that the organization will win the bidding opportunity. As shown in this example, bid assessment questions may be grouped into subsections according to various bid assessment factors (i.e., factors relevant to the overall likelihood of winning a bidding opportunity). In this example, FIGS. 3B-3H relate to various management and technical factors used in assessing the organization's likelihood of winning the bidding opportunity, and FIGS. 3I-3L relate to various cost factors.

When presenting the bid assessment questions to the user in step 202, the sequence of questions may be dynamically determined based on the user's answers. For example, referring to Question 1.1 on FIG. 3B, if the user selects the answer (a), the system 110 may skip the remaining questions on FIG. 3B and the next question presented to the user would be Question 2.1 on FIG. 3C. Alternatively, if the user selects the answer (b) to Question 1.1, the system 110 may retrieve and present Question 1.2 as the next question, and if the user selects answers (c) or (d), the system 110 may retrieve and present Question 1.3 as the next question. Thus, a system component (e.g., question selector 155) may be configured to retrieve and present a single bid assessment question to the user, then receive and evaluate the user's answer, and then determine and retrieve the next question that will be presented to the user. In other examples, sets of bid assessment questions may be designed so that the multiple questions may be retrieved and presented to the user sequentially, regardless of the user's answers. In these examples, the system 110 need not store or implement a dynamic sequence of bid assessment questions.

When presenting bid assessment questions in step 202, the bid assessment analytics system 110 may allow users to partially complete a set of questions for a bid assessment, and then save the questions/answers so that the user may return and complete the bid assessment at a later time. Additionally, different subsets of bid assessment questions may be designated for different specific users. For example, a subset of technical questions in a bid assessment may be assigned to a specific technical employee, while a subset of financial questions for the same bid assessment may be assigned to a different financial employee within an organization. The system 101 may save in-progress bid assessments completed by different users, and may notify users when they have been assigned to answer a subset of questions for a bid assessment. The system 110 may coordinate the interactions of the various users, allowing different users with different areas of expertise to collaborate on a single bid assessment.

In step 203, the bid assessment analytics system 110 may receive answers to the bid assessment questions presented in step 202 and determine an initial total bid assessment score based on the received answers. An organization's initial bid assessment score may be calculated by temporarily storing the user's answers to a complete set of bid assessment questions (e.g., FIGS. 3B-3L), and retrieving score values for each answer from a bid assessment score database 160. For example, referring to Question 1.6 on FIG. 3B, answer (a) may correspond to 3 points, answer (b) may correspond to 1 point, and answer (c) may correspond to 0 points. The user's scores may be summed for each subsection of questions corresponding to each bid assessment factor (e.g., FIGS. 3B-3L), and a total initial bid assessment score may be calculated by summing the scores for each bid assessment factor. Additionally, as described below, the user's answers to the bid assessment questions may be permanently stored in a system database, or other external database, to be analyzed and used as analytics data in future bid assessments.

In step 204, after a set of bid assessment questions have been answered by one or more users associated with a bidding organization (e.g., supplier or contractor), the bid assessment analytics system 110 may continue the bid assessment process by retrieving user analytics data, organization analytics data, and/or industry analytics data from an analytics database 121 or other storage system. Analytics data refers to data generated based on analyses of previous bidding opportunities. For example, the system 110 may store previous answers to bid assessment questions provided by the users of an organization for one or more previous bidding opportunities in user profiles and/or organization profiles in a database 121 or other storage system. The system 110 may also store the outcomes (or results) from these previous bidding opportunities and related information, for instance, whether or not the organization won a previous bidding opportunity, any specific factors or reasons provided by the customer indicating why the organization won or lost the previous bidding opportunity, any available characteristics of the winning or losing bids by other organizations for the previous bidding opportunity, and any other data relating to previous bidding opportunities. In certain embodiments, the system 110 may use notifications and additional user interfaces to prompt users to input the results from bidding opportunities after they are known to the organization. The system 110 may also automatically retrieve previous bidding opportunity results (e.g., governmental RFP bid awards) from publicly available sources.

To generate analytics data, the system 110 may store information provided by the organization users during previous bidding opportunities, for example, previous answers to bid assessment questions, and the corresponding outcomes or results of the previous bidding opportunities. Data regarding the previous bidding opportunities may be associated with specific users, organizations, and/or industries related to the previous bidding opportunities. The system 110 may perform a series of analyses (e.g., regression analyses) on the previous bidding opportunity data and results to determine which answers, combinations of answers, or factors of answers, may be more or less important in determining whether or not the organization's proposal will be successful. Based on these analyses, the bid assessment scoring system may be modified, for example, by changing the set of questions that are asked in bid assessment, or by adjusting the scores of certain answers to bid assessment questions or combinations of questions. In certain examples, N-dimensional statistical estimation techniques may be used to modify the bid assessment scoring system. As new data becomes available (e.g., previous bid assessment details and bid outcomes for specific users, companies, industries, etc.), an N-dimensional statistical estimation may be used to update bid assessment questions and/or scores for certain users, companies, and/or industries. Such estimation techniques may be performed periodically or continuously as new data points become available, so that the bid assessment scoring system 110 may be updated automatically in a manner that is transparent to the users of the system.

Referring again to the FIGS. 3A-3L, the set of bid assessment questions shown in this example may correspond to a general set of bid assessment questions that will be used for all bid assessments performed by all users and for all organizations. In other examples, the set of bid assessment questions in FIGS. 3A-3L may be stored and used only for a specific organization (or for specific users at an organization). Different sets of bid assessment questions may be stored and used for different organizations, or for different users within the same organization. Additionally, different sequences of bid assessment questions may be stored and used for different organizations, or for different users within the same organization. As described above, the sequence of bid assessment questions presented to the user in step 202 may be dynamically determined based on the user's answers. Thus, different sets of mappings from specific bid assessment answers to subsequent questions (e.g., if the user selects answer (c) to Question 1.1 on FIG. 3B, then the system 110 should next present Question 1.3) may be stored and used for different organizations, or for different users within the same organization.

The first time an organization (or individual user) uses the bid assessment analytics system 110, the system may have no previous data regarding the organization's or user's past bidding opportunities. In this case, there may be no bid assessment analytics data available for retrieval in step 204, and the system 110 may perform a bid assessment for the organization using a generic set of questions (e.g., FIGS. 3A-3L), and a standard set (e.g., industry-wide) of score values. Additionally, in this case there may be no adjustments (discussed later in step 205) to the initial bid assessment score values determined in step 203.

However, after the system 110 has performed one or more bid assessments for an organization, or has been provided with past bidding opportunity and outcome data, the system 110 may analyze this data to generate adjustments to the score values of the bid assessment questions, in order to more accurately predict bidding opportunity success and failure for the organization. The system 110 may modify the questions and/or score values for bid assessment questions by adding new questions or removing questions (i.e., marking or designating questions so that they will not be asked in subsequent bid assessments performed for the organization), changing the sequence of questions, or using score adjustments to increase or decrease score values for certain answers to bid assessment questions or combinations of questions. These modifications may be made using N-dimensional statistical estimation techniques, and may be transparent to system users. Thus, bid assessments for specific users, companies, and/or industries (e.g., the sequences of questions asked, answer scores, scoring adjustments, etc.) may be changed automatically based on statistical estimation techniques, without the users of the system 110 having any knowledge of the changes.

As an example, after performing several bid assessments for an organization, or analyzing previous bid opportunity and outcome data provided by the organization, the bid assessment analytics system 110 may determine that the organization's actual win rate for bidding opportunities is higher than the win rate predicted using the initial set of questions and score values in FIGS. 3A-3L. In this case, the organization may be understating some of its capabilities or attributes when responding to bid assessment questions, or there may be other qualities to the organization that are not reflected by the answers to the bid assessment questions. As a result, the system 110 may adjust several score values associated with the bid assessment answers in FIGS. 3A-3L by small amount, in order to move the organization's predicted win rate closer to its actual win rate. As another example, the system 110 may determine that the organization wins a higher than expected rate of bidding opportunities when its “Customer Relationship” factor score (e.g., Factor 2 on FIGS. 3C-3D) is high, and loses a higher than expected rate of bidding opportunities when its Customer Relationship factor score is low. As a result, the system 110 may adjust the score values associated with the bid assessment answers in FIGS. 3C-3D in order to amplify both the higher and lower Customer Relationship factor scores, and thus increase the effect of positive and negative Customer Relationship factor scores on the overall predicted likelihood of winning a bidding opportunity.

The examples in the previous paragraph describe modifying a bid assessment process (e.g., modifying questions, question sequences, score values, etc.) for an organization, in order to improve the predictive power of the bid assessment process in determining whether or not the organization will win a bidding opportunity. Bid assessment modifications also may be performed based on the individual users interacting with the system 110, the industry of the organization and bidding opportunity, and for additional variables/combinations of variables.

For example, after the system 110 has performed one or more bid assessments for a supplier, the system 110 may determine that when Employee A answers the bid assessment questions for the supplier, the predicted likelihood of winning the bid is higher than when other employees of the supplier answer the bid assessment questions. In this case, Employee A may be generally more optimistic or more interested in the supplier winning bidding opportunities, and thus Employee A may be answering the bid assessment questions more subjectively and less accurately. For instance, Employee A may be overrating the past successes of the supplier's technical approach and thus causing too high of a “Technical Approach” factor score (see Factor 6 on FIG. 3H). As a result, the system 110 may generate analytics data that apply only to subsequent bid assessment questions answered by Employee A, for example, a downward adjustment for Employee A's answers to certain bid assessment questions, bid assessment factors, overall bid assessment scores, in order to bring the scores for bid assessments performed by Employee A in line with the scores for bid assessments performed by other employees of the supplier. The system 110 may use statistical estimations (e.g., using N-dimensional statistical estimation techniques) to scale the scores for bid assessments performed by Employee A to those performed by other employees in the same company. Similar statistical estimations may be used to scale one company's bid assessment scores to those of other companies in the same industry.

As another example, after performing a number of bid assessments, or after processing data from previous bid assessments, the system 110 may determine that bid assessment performed for the supplier lead to underestimations of the likelihood of the supplier winning a contract for certain products or in certain industries, and overestimations of the likelihood of the supplier winning a contract for other products or in other industries. In this case, the system 110 may use statistical estimations (e.g., N-dimensional statistical estimation techniques) to scale the scores for a supplier's bid assessments for bids in certain industries to those in other the supplier's other industries. Score adjustments based on the scaling may be stored as analytics data by the system 110 to allow the system to adjust the supplier's bid assessment answer scores for bids in certain industries, and/or apply an opposite adjustment for the supplier's scores for bids in other industries.

In step 205, the bid assessment analytics system 110 may use the analytics data retrieved in step 204 to adjust the initial bid assessment scores determined in step 203. The retrieved score adjustments may be numerical values corresponding to individual answers in the set of bid assessment questions (e.g., FIGS. 3B-3L). For example, referring again to FIG. 3B, the system 110 may determine, based on the analytics data in the database 170, that the score value assigned to answer (a) for Question 1.6 should be adjusted by +1 for a specific user, organization, or industry. Thus, although the initial bid assessment in step 203 may score 3 points for all users who answer (a) to Question 1.6, in step 205 this value may be adjusted to 4 points for a specific user, organization, or industry, based on the analytics data stored in database 170. Score adjustments may also apply to combinations of questions, rather than to specific questions. For example, based on analytics data, the system 110 may determine that the score for a bid assessment factor (e.g., Factor 1 on FIG. 3B) should be adjusted up or down by a number of points.

In these examples, the modifications to the bid assessment process for an organization, user, and/or industry, may be stored by the system 110 in a database 121 or other storage system, and may be used in subsequent bid assessments performed by the system 110. Thus, the system 110 may store different sets of bid assessment questions, question sequences, and score value adjustments for bid assessment questions, for different organizations, users of an organization, or for different industries. In these examples, the adjustments (e.g., score value adjustments for bid assessment questions) may be applied automatically by the system 110 whenever a bid assessment is performed for the corresponding organization, user, and/or industry. The adjustments stored in the data analytics database 170 or other storage may be added, removed, and modified on an ongoing basis, as new bidding opportunity and outcome data is analyzed by the system 110. As described above, such adjustments may be made using N-dimensional statistical estimation techniques, and may be transparent to the users, organizations, and/or industries to which the adjustments are applied.

In step 206, the bid assessment analytics system 110 may generate and present a bid assessment report. In certain examples, bid assessment scores may be calculated and bid assessment reports may be organized according to bid assessment factors (e.g., FIGS. 3B-3L). Referring to FIGS. 3B-3L, in this example a bid assessment report may include scores and analysis broken down into the following factors: Understanding the Problem (FIG. 3B); Customer Relationship (FIGS. 3C-3D); Competitive Landscape (FIG. 3E); Teaming (FIG. 3F); Management Approach (FIG. 3G); Technical Approach (FIG. 3H); Procurement/Cost Dynamics (FIG. 3I); Customer Business Dynamics (FIG. 3J); Customer Source Selection (FIG. 3K); and Your Company Dynamics (FIG. 3L). In this example, each bid assessment question is associated with a single factor, and the questions are grouped by factor and presented in corresponding sections in the user interface and in the bid assessment report. In other examples, certain questions may be relevant for multiple factors, so that the answer to a single bid assessment question may contribute to the scores for multiple different factors.

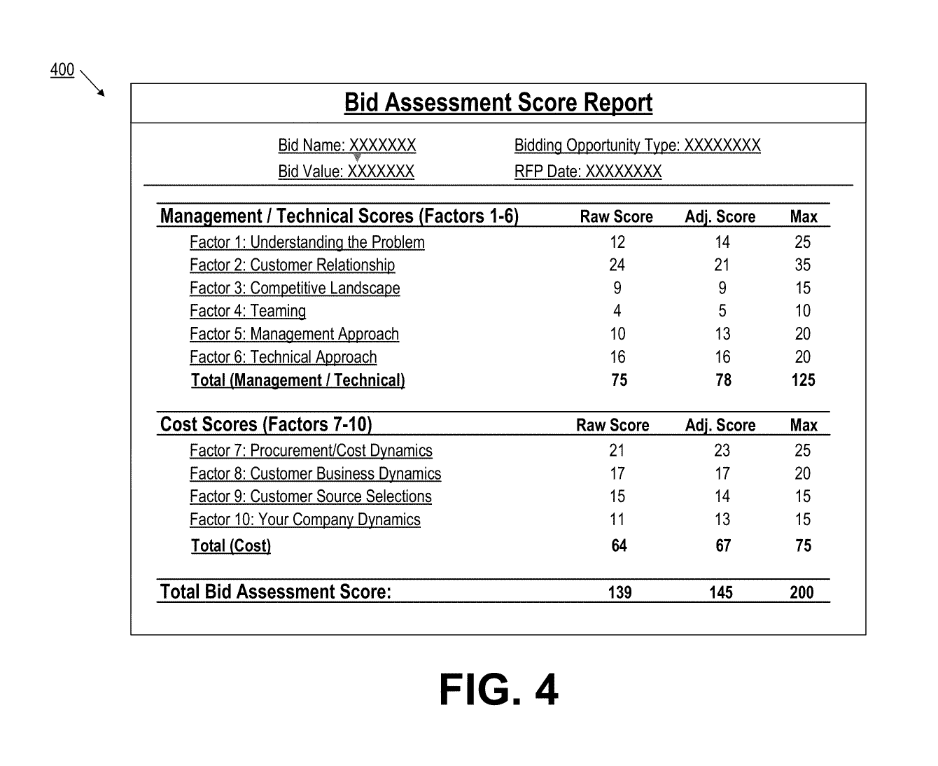

Referring now to FIG. 4, an example user interface 400 is shown for a bid assessment report, displaying a set of bid assessment scores based on the example bid assessment questions in FIGS. 3A-3L. In this example, the system 110 has calculated an initial (or “raw”) bidding assessment factor score (see step 203), an adjusted bidding assessment factor score (see step 205), and the maximum score for each of the bid assessment factors shown in FIGS. 3B-3L. The bid assessment factors are further grouped into two factor groups: Management/Technical Factors (corresponding to Factors 1-6 in FIGS. 3B-3H) and Cost Factors (corresponding to Factors 7-10 in FIGS. 3I-3L). The bid assessment report may also include a bid name, bid value, bidding opportunities type (from FIG. 3A), and an RFP date, along with other information relating to the bidding opportunity. The overall adjusted score (145 out of 200 in FIG. 4), as well as the individual adjusted factor scores, may allow users to determine the likelihood of an organization winning a bidding opportunity (e.g., an RFP from a governmental entity). In certain examples, the bid assessment report may use the total bid assessment scores (and/or bid assessment factor scores and factor group scores) to calculate a percentage likelihood of the organization winning the bidding opportunity. For instance, the previous bid assessment data for an organization may indicate that when the total bid assessment score for the organization is 145 out of 200 points as shown in FIG. 4, the organization has a 70% likelihood of winning the bidding opportunity. Percentage likelihoods for winning bidding opportunities may be calculated and displayed in bid assessment reports based on total bid assessment scores and/or based on individual bid assessment factor scores.

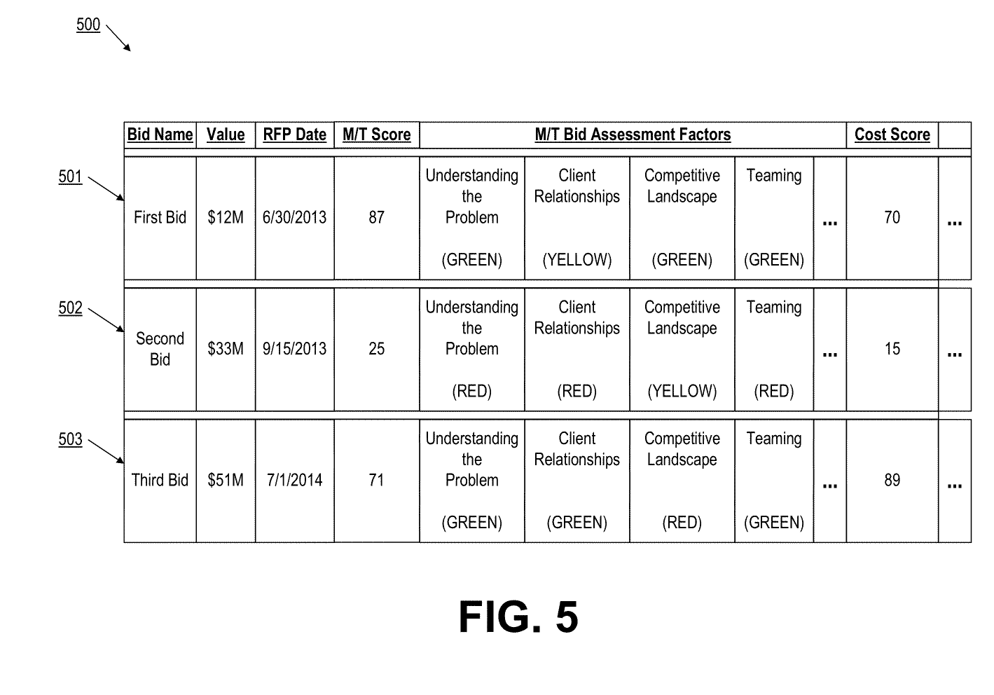

Referring to FIG. 5, another example user interface is shown for a bid assessment report. In this example, FIG. 5 includes a set of bid assessment scores broken down by bid assessment factors, for three separate bid assessments 501-503 performed for an organization. In this example, the results of the three bid assessments 501-503 are displayed in a table 500 for review, comparison, and analysis by members of the organization. For each bid assessment 501-503, a bid name (e.g., RFP title), bid value, and RFP date are displayed in the bid assessment report. Additionally, the table 500 includes the bid assessment factor scores for each bid assessment factor shown in FIGS. 3B-3L. Color indicators (or numerical scores in other examples) for each factor indicate the strength of the organization regarding that factor, with respect to potentially winning the bidding opportunity. As in the previous example, the bid assessment factors are further grouped into two factor groups: Management/Technical Factors (corresponding to Factors 1-6 in FIGS. 3B-3H) and Cost Factors (corresponding to Factors 7-10 in FIGS. 3I-3L), and a score value for each factor group is shown in the bid assessment report. For example, for the first bid 501, a user may observe that the organization has a management/technical factor score of 87 and a cost factor score of 70. Additionally, users may observe in table 500 certain factors for certain bid assessment colored green, indicating high factors scores for those sections, certain sections are colored yellow, indicating medium range scores for those sections, and certain sections are colored red, indicating low scores for those sections. As shown in FIG. 5, the organization is more likely to win the first bid 501 than the second bid 502, which includes lower overall scores and several yellow and red colored sections. The coloring scheme and threshold values may be configurable by the system 110.

The system 110 may be configured to allow users and organizations to run multiple bid assessments for a single bidding opportunity. For example, the third bid 503 in FIG. 5 includes generally high scores for management/technical and cost factors, and several green colored sections indicating high scores for various bid assessment factors. However, the organization may observe that its “Competitive Landscape” factor score in the third bid 503 is low. Thus, after performing bid assessment 503, the organization may take steps to improve its “Competitive Landscape” factor score, for example, hiring additional personnel, implementing new procedures, addressing certain technical needs, gaining additional experiences on similar projects, etc. After implementing these steps, or while attempting to determine if the benefits of implementing the steps will be worth the costs, the organization may use the system 110 to perform another bid assessment on the third bid 503. The system 110 may prompt the user to re-answer one or more sections of bid assessment questions (e.g., the entire set of bid assessment questions, or only the questions for one or more bid assessment factors of interest to the organization). In response to the user or organization performing a subsequent bid assessment, the system 110 may update table 500 with the revised bid assessment scores and analyses for bid 503.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
retrieve a plurality of predetermined bid assessment questions for a first bid assessment and present the plurality of predetermined bid assessment questions via a user interface;
receive answers to the plurality of predetermined bid assessment questions via the user interface;
determine a score associated with each question based on the answer received to the question;
for each of one or more bid assessment factors, determine a subset of questions associated with the bid assessment factor;
for each of the bid assessment factors, calculate a bid assessment factor score based on the score of the subset of questions associated with the bid assessment factor; and
output the bid assessment factor score for each of the one or more bid assessment factors.

2. The apparatus of claim 1, the memory storing further computer-readable instructions that, when executed by the at least one processor, cause the apparatus to:
calculate an overall bid assessment score for the first bid assessment, based on the bid assessment factor scores for each of the one or more bid assessment factors; and
output the overall bid assessment score for the first bid assessment.

3. The apparatus of claim 2, wherein the overall bid assessment score for the first bid assessment corresponds to a likelihood of winning a bidding opportunity.

4. The apparatus of claim 1, the memory storing further computer-readable instructions that, when executed by the at least one processor, cause the apparatus to:
determine a first organization associated with the first bid assessment;
retrieve one or more bid assessment adjustment values associated with the first organization from a database; and
adjust one or more of the bid assessment factor scores based on the bid assessment adjustment values associated with the first organization.

5. The apparatus of claim 4, wherein the database comprises a different set of bid assessment adjustment values for each of a plurality of organizations.

6. The apparatus of claim 4, the memory storing further computer-readable instructions that, when executed by the at least one processor, cause the apparatus to:
calculate the bid assessment adjustment values associated with the first organization based on data from one or more previous bid assessments associated with the first organization, the data including responses by the first organization to the plurality of predetermined bid assessment questions for the one or more previous bid assessments and the results of bidding opportunities associated with the one or more previous bid assessments.

7. The apparatus of claim 1, the memory storing further computer-readable instructions that, when executed by the at least one processor, cause the apparatus to:
determine a first industry associated with the first bid assessment;
retrieve one or more bid assessment adjustment values associated with the first industry from a database; and
adjust one or more of the bid assessment factor scores based on the bid assessment adjustment values associated with the first industry.

8. The apparatus of claim 1, the memory storing further computer-readable instructions that, when executed by the at least one processor, cause the apparatus to:
identify a first user interacting with the user interface to perform the first bid assessment;
retrieve one or more bid assessment adjustment values associated with the first user from a database; and
adjust one or more of the bid assessment factor scores based on the bid assessment adjustment values associated with the first user.

9. The apparatus of claim 1, wherein presenting and receiving answers to the plurality of predetermined bid assessment questions comprises:
presenting a first bid assessment question via the user interface;
receiving an answer to the first bid assessment question via the user interface;
determining a second bid assessment question from the plurality of predetermined bid assessment questions, wherein the second bid assessment question is determined based on the answer to the first bid assessment question; and
presenting the second bid assessment question via the user interface.

10. A method, comprising:
retrieving, by a bid assessment analytics system, a plurality of predetermined bid assessment questions for a first bid assessment and presenting the plurality of predetermined bid assessment questions via a user interface;
receiving answers to the plurality of predetermined bid assessment questions via the user interface;
determining, at the bid assessment analytics system, a score associated with each question based on the answer received to the question;
for each of one or more bid assessment factors, determining a subset of questions associated with the bid assessment factor;
for each of the bid assessment factors, calculating a bid assessment factor score based on the score of the subset of questions associated with the bid assessment factor; and
outputting, by the bid assessment analytics system, the bid assessment factor score for each of the one or more bid assessment factors.

11. The method of claim 10, further comprising:
calculating an overall bid assessment score for the first bid assessment, based on the bid assessment factor scores for each of the one or more bid assessment factors; and
outputting the overall bid assessment score for the first bid assessment.

12. The method of claim 10, further comprising:
determining a first organization associated with the first bid assessment;
retrieving one or more bid assessment adjustment values associated with the first organization from a database; and
adjusting one or more of the bid assessment factor scores based on the bid assessment adjustment values associated with the first organization.

13. The method of claim 12, wherein the database comprises a different set of bid assessment adjustment values for each of a plurality of organizations.

14. The method of claim 12, further comprising:
calculating the bid assessment adjustment values associated with the first organization based on data from one or more previous bid assessments associated with the first organization, the data including responses by the first organization to the plurality of predetermined bid assessment questions for the one or more previous bid assessments and the results of bidding opportunities associated with the one or more previous bid assessments.

15. The method of claim 10, further comprising:
identifying a first user interacting with the user interface to perform the first bid assessment;
retrieving one or more bid assessment adjustment values associated with the first user from a database; and
adjusting one or more of the bid assessment factor scores based on the bid assessment adjustment values associated with the first user.

16. The method of claim 10, wherein presenting and receiving answers to the plurality of predetermined bid assessment questions comprises:
presenting a first bid assessment question via the user interface;
receiving an answer to the first bid assessment question via the user interface;
determining a second bid assessment question from the plurality of predetermined bid assessment questions, wherein the second bid assessment question is determined based on the answer to the first bid assessment question; and
presenting the second bid assessment question via the user interface.

17. One or more non-transitory computer-readable media storing computer-executable instructions which, when executed on a computer system, cause the computer system to:
retrieve a plurality of predetermined bid assessment questions for a first bid assessment and present the plurality of predetermined bid assessment questions via a user interface;
receive answers to the plurality of predetermined bid assessment questions via the user interface;
determine a score associated with each question based on the answer received to the question;
for each of one or more bid assessment factors, determine a subset of questions associated with the bid assessment factor;
for each of the bid assessment factors, calculate a bid assessment factor score based on the score of the subset of questions associated with the bid assessment factor; and
output the bid assessment factor score for each of the one or more bid assessment factors.

18. The computer-readable media of claim 17, the storing further computer-executable instructions which, when executed on the computer system, cause the computer system to:
calculate an overall bid assessment score for the first bid assessment, based on the bid assessment factor scores for each of the one or more bid assessment factors; and
output the overall bid assessment score for the first bid assessment.

19. The computer-readable media of claim 17, storing further computer-executable instructions which, when executed on the computer system, cause the computer system to:
determine a first organization associated with the first bid assessment;
retrieve one or more bid assessment adjustment values associated with the first organization from a database; and
adjust one or more of the bid assessment factor scores based on the bid assessment adjustment values associated with the first organization.

20. The computer-readable media of claim 19, wherein the database comprises a different set of bid assessment adjustment values for each of a plurality of organizations.

21. The computer-readable media of claim 19, storing further computer-executable instructions which, when executed on the computer system, cause the computer system to:
calculate the bid assessment adjustment values associated with the first organization based on data from one or more previous bid assessments by the first organization, the data including responses by the first organization to the plurality of predetermined bid assessment questions for the one or more previous bid assessments and the results of bidding opportunities associated with the one or more previous bid assessments.

22. The computer-readable media of claim 17, storing further computer-executable instructions which, when executed on the computer system, cause the computer system to:
identify a first user interacting with the user interface to perform the first bid assessment;
retrieve one or more bid assessment adjustment values associated with the first user from a database; and
adjust one or more of the bid assessment factor scores based on the bid assessment adjustment values associated with the first user.

23. The computer-readable media of claim 17, wherein presenting and receiving answers to the plurality of predetermined bid assessment questions comprises:
presenting a first bid assessment question via the user interface;
receiving an answer to the first bid assessment question via the user interface;
determining a second bid assessment question from the plurality of predetermined bid assessment questions, wherein the second bid assessment question is determined based on the answer to the first bid assessment question; and
presenting the second bid assessment question via the user interface.
